(19) United States
(12) Patent Application Publication
(10) Pub. No.: US 2014/0313118 A1
(43) Pub. Date: Oct. 23, 2014

(54) COMMUNICATION APPARATUS

(71) Applicant: PANASONIC CORPORATION, Osaka (JP)

(72) Inventors: Alexander R. BROWN, San Jose, CA (US); Haoyu Feng, Sunnyvale, CA (US); Tark Abed, Palo Alto, CA (US); Luca Rigazio, San Jose, CA (US)

(21) Appl. No.: 13/866,708

(22) Filed: Apr. 19, 2013

(51) Int. Cl. A45F 5/00; G06F 3/041

(52) U.S. Cl. CPC A45F 5/00; G06F 3/041
USPC 345/156; 224/218

(57) ABSTRACT

An apparatus includes a housing, a band which is provided on side of the housing and has a longer length than a circumference of the housing, and a supporter configured to support the band on the side of the housing to enable the band to slide along the side of the housing. The apparatus may include a detector configured to detect a form of the band; a display configured to display a user interface for operating the communication apparatus and a controller configured to control a display position of the user interface based on the form of the band. The detector may detect pressure applied by the band on the housing, and the controller may estimate the form of the band on the basis of the pressure and to control the display position of the user interface on the basis of the estimation result.

### TECHNICAL FIELD

The present invention relates to a communication apparatus such as a tablet computer apparatus such as a mobile computer, including for example a touchscreen or pen-enabled interface, which has an slidable band for adjusting a grip position according to a usage condition.

### RELATED ART

In cases of conventional tablet computer apparatuses, difficulties exist with respect to operating and carrying them depending on the usage environment.

For instance, it can be assumed that a user works with one hand while operating the conventional tablet apparatuses with the other hand.

However if the user does something with one hand while using the conventional tablet apparatus with the other hand, the user needs to grip the conventional tablet apparatus with only the other hand to support the tablet apparatus. Thus, the user is prone to be tired in case of one hand operation of the conventional tablet apparatus. Accordingly, it is difficult to do something with one hand while using the conventional tablet apparatus with the other hand for a long time.

Also icons for operating conventional tablet apparatuses may be displayed on the screen at a position outside of the reach of the user's finger. In this case, it is impossible to operate the conventional tablet apparatus with one hand and the user needs the other hand to operate the conventional tablet apparatus. In such case, the user cannot do other work while operating the conventional tablet apparatus. Accordingly, the operational efficiency becomes lower.

### SUMMARY

The present disclosure concerns an apparatus comprising a housing; a band which is provided on side of the housing and has a longer length than a circumference of the housing; and a supporter configured to support the band on the side of the housing to enable the band to slide along the side of the housing.

The band may comprise rubber material. The housing may include at least one chamfered corner.

The apparatus may further include a detector configured to detect a form of the band; a display configured to display a user interface for operating the communication apparatus; and a controller configured to control a display position of the user interface based on the form of the band.

The detector may comprise at least one pressure sensor disposed on the side of the housing, the pressure sensor being configured to detect pressure applied by the band on the housing, and the controller may be configured to estimate and provide an estimation result of the form of the band on the basis of the pressure and to control the display position of the user interface on the basis of the estimation result. Various types of pressure sensors suitable for use in the detector described above are well known to those skilled in the art.

The apparatus may further comprise a position detector configured to detect a position of the communication apparatus, wherein the controller is configured to control the display position of the user interface on the basis of the position of the communication apparatus and the form of the band.

The position detector may include an acceleration sensor configured to detect an acceleration of the communication apparatus and a gyroscopic sensor configured to detect an angle of the communication apparatus.

The user interface may comprise at least one of an icon, command, a software keyboard and an operating screen for controlling the communication apparatus.

### BRIEF DESCRIPTION OF Tiff DRAWINGS

FIG. 1 is a diagram illustrating external view of a communication apparatus.

FIG. 2A and FIG. 2B are diagrams illustrating external views of the communication apparatus when using.

FIG. 3A-3C are diagrams illustrating adjustments of icon displaying position in accordance with type of usage.

FIG. 4 is a block diagram illustrating hardware of the communication apparatus.

FIG. 5 is a diagram illustrating installation positions of holding mode sensors.

FIG. 6 is a diagram illustrating relation between outputs of the holding mode sensors and forms of a rubber band.

FIG. 7 is a flowchart regarding control of icon displaying position.

FIG. 8 is a diagram illustrating a external view of the communication apparatuses and a charging device.

FIG. 9 is a block diagram illustrating hardware of the charging device and hardware of power receiving system of the communication apparatuses.

FIG. 10 is a flowchart regarding motion of the charging device in charging operation.

FIG. 11 is a flowchart regarding motion of the communication apparatus in charging operation.

### DETAILED DESCRIPTION

The embodiments are explained with reference to the drawings. Similar elements among the drawings are allocated with the same reference numerals.

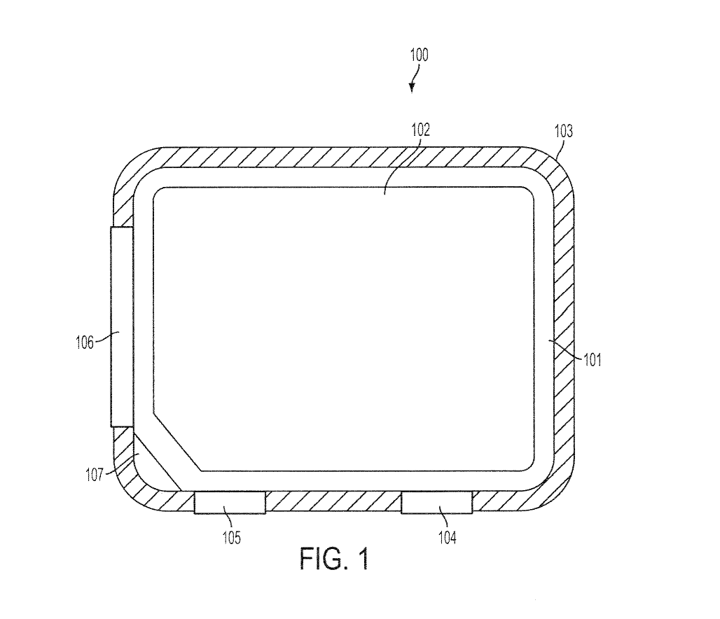

FIG. 1 shows an external view of communication apparatus 100. Communication apparatus 100 includes housing 101, display 102, elastic band 103 (such as a rubber band), and supporting members 104, 105 and 106.

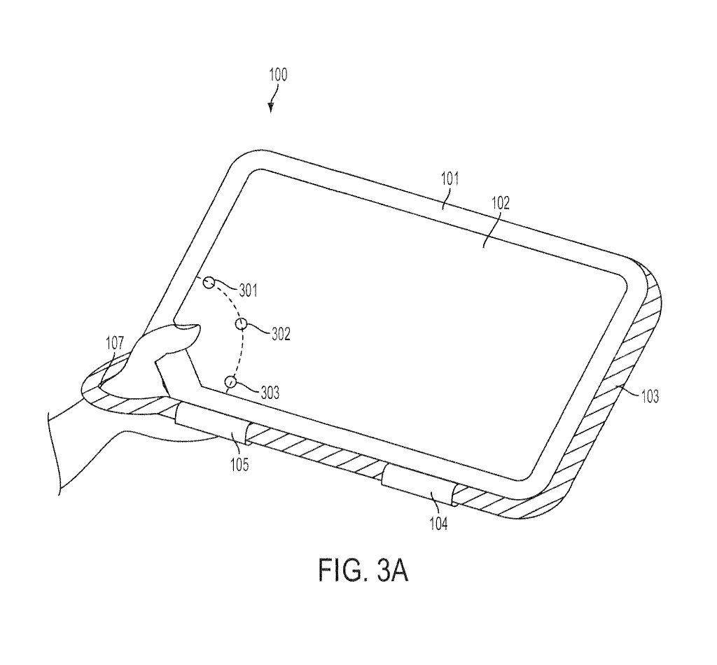

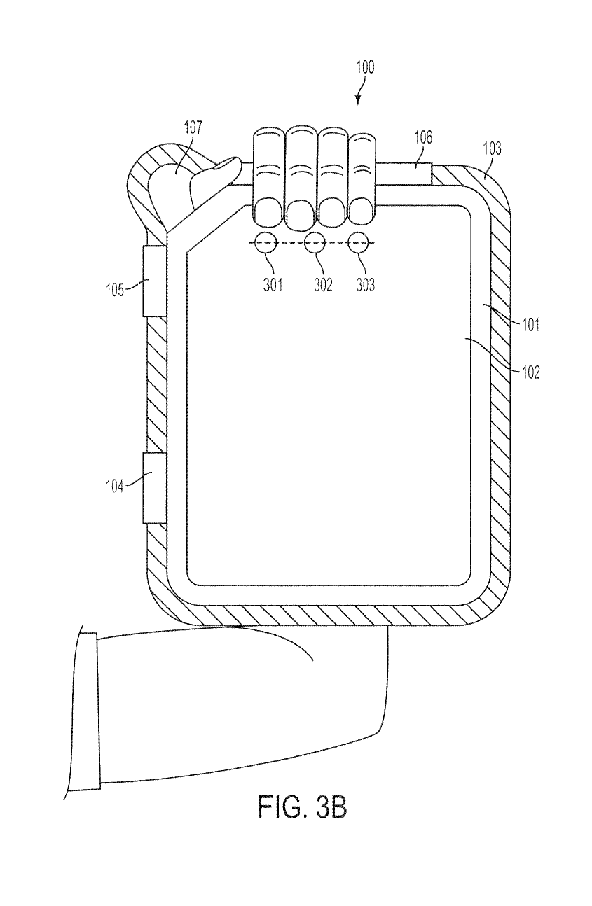

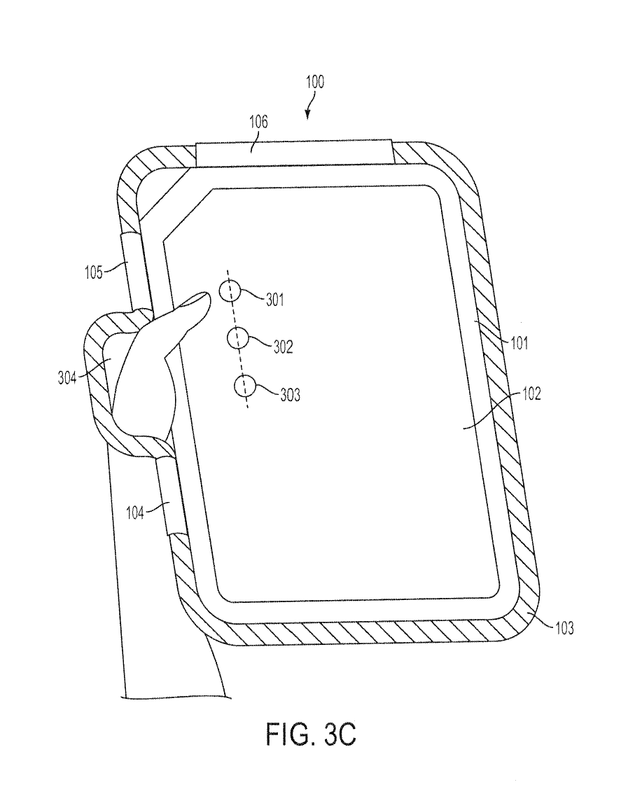

Housing 101 has four corners. As shown, among them, three corners have a rounded shape respectively, and the remaining one corner is chamfered. Display 102 displays at least one user interface for controlling communication apparatus 100. The user interface may include a set of commands or menus through which a user communicates with a program stored in the tablet apparatus. In a command-driven interface, the user enters commands; while in a menu-driven interface, the user selects command choices from various menus displayed on the screen. FIG. 3A shows icons 301, 302 and 303 which form part of the user interface.

Display 102 also has a touch panel function. Users can control communication apparatus 100 by touching the user interface displayed on display 102. Rubber band 103 having an annular cross-section shape is provided on the sides of housing 101. The length of rubber band 103 is longer than the length of the circumference of housing 101. Therefore it is possible that space 107 is provided between housing 101 and rubber band 103. Rubber band 103 is formed of elastic material (e.g. natural rubber, synthetic rubber etc.). In case that communication apparatus 100 falls to the ground, rubber band 103 performs as a shock absorbing material. Also, it is possible to use a plastic band instead of rubber band 103.

Supporting members 104, 105 and 106 are annular sleeves for supporting rubber band 103 on the sides of housing 101. Supporting members (sleeves) 104, 105 and 106 are fixed on the sides of housing 101 by using adhesive materials and/or screws (not shown). In case that a user pulls rubber band 103, rubber band 103 can pass through the supporting members 104, 105 and 106 and slide along the sides of housing 101. The cross-sectional shape of supporting members 104, 105 and 106 are selected in accordance with the cross-sectional shape of rubber band 103. For instance, if the cross-sectional shape of rubber band 103 has a quadrangular shape, the same shape is selected as the cross-sectional shape of supporting member 104, 105 and 106. Also, either an open shape and a closed, shape is suitable for the cross-sectional shape of supporting members 104, 105 and 106.

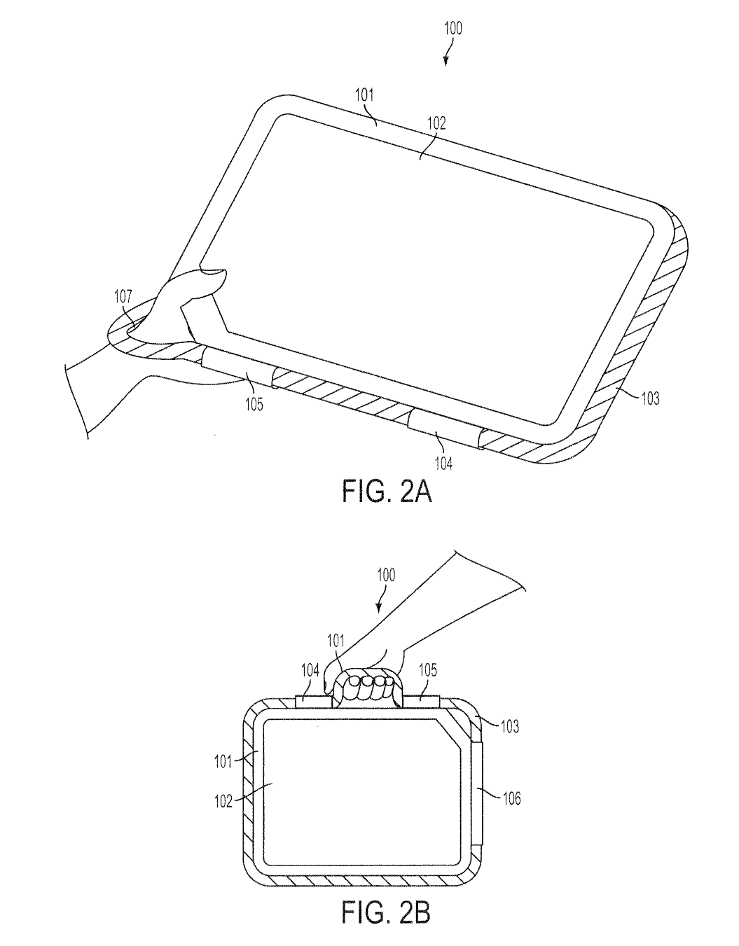

FIG. 2A shows external views of the communication apparatus 100 when in use. As shown in FIG. 2A, the user grips communication apparatus 100 while inserting their thumb into space 107 provided between housing 101 and rubber band 103. In this case, the user can grip communication apparatus 100 while hitching their thumb to rubber band 103. In this way, it is possible that the user avoids a strain. Accordingly, it becomes easier for the user to do other work while operating communication apparatus 100 for a long time.

FIG. 2B shows external views of the communication apparatus 100 when being carried by the user. As shown in FIG. 2B, the user can prepare grip 201 by holding up a part of rubber band 103 between supporting member 104 and supporting member 105 to slide rubber band 103 along the side of housing 101. Therefore, the user can move smoothly by gripping grip 201.

FIGS. 3A, 3B and 3C show adjustments of an icon displaying position in accordance with the type of usage. As shown in FIGS. 3A, 3 and 3C, displaying positions of icons 301, 302 and 303 vary in accordance with a form of rubber band 103 and/or a position (e.g. inclination angle or other orientation position) of communication apparatus 100. Controlling of displaying position of icons 301, 302 and 303 are described below.

FIG. 3A shows the first example of displaying position of icons 301, 302 and 303. More specifically, FIG. 3A shows displaying positions of icons 301, 302 and 303 when the user grips communication apparatus 100 while inserting their thumb into space 107. As shown in FIG. 3A, icons 301, 302 and 303 are displayed in the vicinity of the user's thumb (i.e. in the vicinity of space 107) so that the user operates communication apparatus 100 with the thumb only. Therefore, the user can operate communication apparatus 100 with one hand with doing another work with the other hand. As the broken line in FIG. 3A shows, icons 301, 302 and 303 are displayed along the circular arc. However it is also fine for icons 301, 302 and 303 to be displayed in a linear arrangement. Also, the number of arranged icons is not limited to three. The user can select the number of displayed icons by configuring communication apparatus 100. Also, the operation of communication apparatus 100 becomes smooth when icons of frequently used programs are displayed in the vicinity of space 107 like icons 301, 302 and 303.

FIG. 3B shows a second example of displaying position of icons 301, 302 and 303. More specifically, FIG. 3B shows displaying positions of icons 301, 302 and 303 when the user holds communication apparatus 100 with one arm and grips communication apparatus 100 while inserting the thumb into space 107. As shown in FIG. 3B, icons 301, 302 and 303 are displayed in the vicinity of the user's first finger through fifth finger so that the user operates communication apparatus 100 with the first finger through fifth finger. Therefore, the user can operate communication apparatus 100 with their first finger through fifth finger of the gripping hand only and can do other work using the other hand. As the broken line in FIG. 3B shows, icons 301, 302 and 303 are displayed oriented on a line. However, icons 301, 302 and 303 may alternatively be displayed on more than two lines. Also, the number of arranged icons is not to be limited to three. The user can select the number of icons displayed near their first finger through fifth finger by configuring communication apparatus 100. Also, the operation of communication apparatus 100 becomes smooth when icons of frequently used programs are displayed in the vicinity the user's first finger through fifth finger like icons 301, 302 and 303.

FIG. 3C shows a third example of a displaying position of icons 301, 302 and 303. More specifically, FIG. 3C shows displaying positions of icons 301, 302 and 303 when the user grips communication apparatus 100 while inserting their thumb into space 304. Space 304 is provided by pulling a part of rubber band 304 between supporting member 104 and supporting member 105. As shown in FIG. 3C, icons 301, 302 and 303 are displayed in the vicinity of the user's thumb (i.e. in the vicinity of space 304) so that the user operates communication apparatus 100 with the thumb as shown. Therefore, the user can operate communication apparatus 100 with the thumb of the gripping hand only and can do other work using the other hand. As the broken line in FIG. 3C shows, icons 301, 302 and 303 are displayed on a line. However, alternatively, icons 301, 302 and 303 may be displayed on more than two lines. Also, the number of arranged icons is not to be limited to three. The user can select the number of icons displayed near space 304 by configuring communication apparatus 100. Also, the operation of communication apparatus 100 becomes smooth when icons of frequently used programs are displayed in the vicinity the user's thumb like icons 301, 302 and 303.

In addition to icons 301, 302 and 303, the above-described controlling technique of the displaying position is applicable to various user interfaces, which is used for controlling communication apparatus 100, including commands, software key, operation screen, and the like. Communication apparatus 100 displays at least one of icons, command software keys and operation screens and implements controlling of display position.

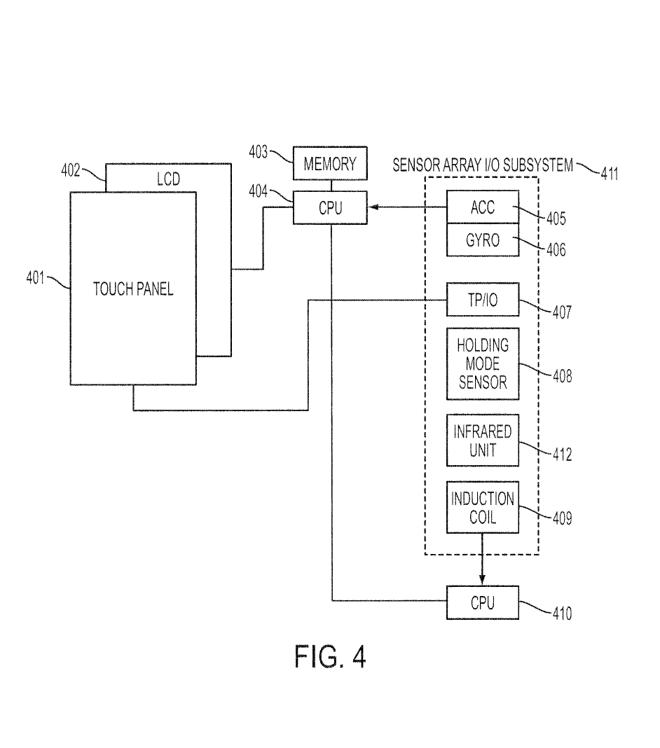

FIG. 4 shows a hardware block diagram of the communication apparatus 100. CPU 404 implements various controls regarding communication apparatus 100. Memory 403 stores necessary information (e.g. programs, codes) for operation of CPU 404 and CPU 410. Sensor array I/O sub system 411 includes acceleration sensor 405, gyroscopic sensor 406, TP/IO (touch panel I/O) 407, holding mode sensor 408, infrared unit 412, and induction coil 409. CPU 410 implements processes regarding outputs from each sensor included in sensor array I/O sub system 411 and output result of the processes to CPU 404. Further, each sensor included in sensor array I/O sub system 411 outputs each detected value to CPU 404 directly. LCD (Liquid Crystal Display) 402 displays various information items (e.g. icons, operation screens and the like) in accordance with instructions from CPU 404.

Acceleration sensor 405 detects an acceleration of communication apparatus 100. Gyroscopic sensor 406 detects an angle of communication apparatus 100 and an angular rate of communication apparatus 100. CPU 410 can estimate a motion and a position of communication apparatus 100 by processing the acceleration of communication apparatus detected by acceleration sensor 405 and the angle and/or the angular rate of communication apparatus 100 detected by gyroscopic sensor 406. TP/IO 407 detects which part of touch panel 401 the user touches and outputs results of this detection to CPU 404 and CPU 410. Holding mode sensor 408 detects pressure applied by rubber band 103 to the sides of housing 101. Holding mode sensor 408 is a pressure sensor utilizing change of capacitance. At least one holding mode sensor 408 is provided on each side of housing 101. CPU 410 can estimate a form of rubber band 103 by processing output from each pressure sensor. Infrared unit 412 transmits and receives necessary information for a charging process with the charging device described below via infrared communication.

CPU 410 estimates a form of rubber band 103 on the basis of output from holding mode sensor 408. Induction coil 409 is utilized for charge of communication apparatus 100 and detection of charge initiation. Information regarding motion and position of communication apparatus 100 and regarding a form of rubber band 103 estimated by CPU 410 are outputted to CPU 404. CPU 404 determines displaying position of icons 301, 302 and 303 on the basis of these information items outputted from CPU 410.

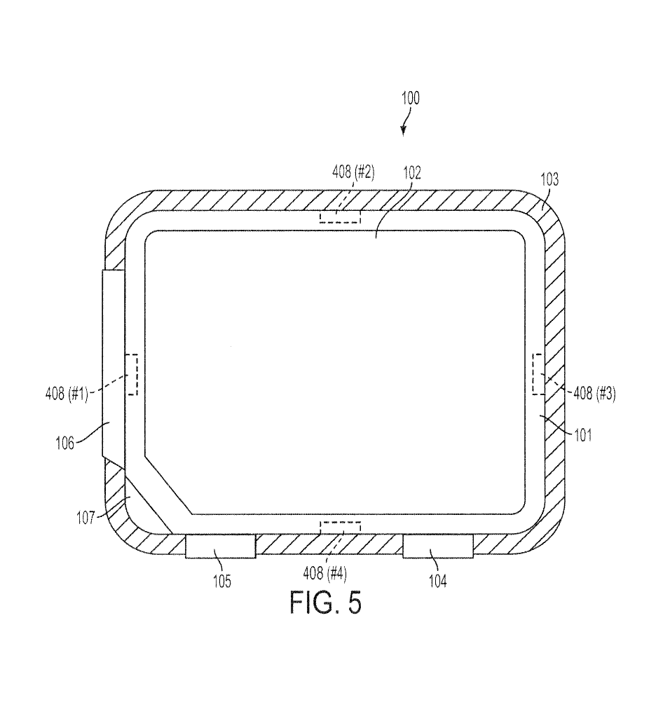

FIG. 5 shows installation positions of holding mode sensors 408. Each holding mode sensor 408 is provided on the middle part of each side of housing 101. Afterward, as shown in FIG. 5, numerical references #1, #2, #3 and #4 are provided to each holding mode sensor 408 to facilitate explanation. Each holding mode sensor 408 outputs electric signal when it detects a predetermined pressure.

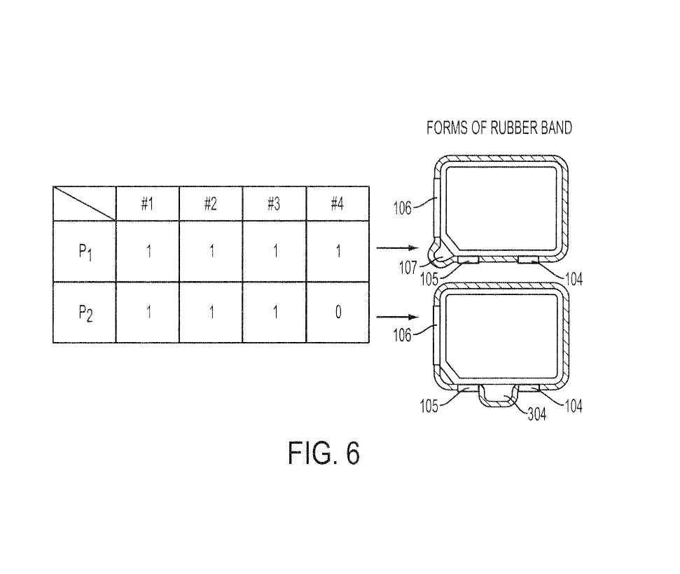

FIG. 6 shows a relationship between outputs of each holding mode sensor 408 and forms of rubber band 103. Value “1” shown in the table indicates that each holding mode sensor 408 detects the predetermined pressure and outputs an electrical signal. On the other hand. Value “0” shown in the table indicates that each holding mode sensor 408 does not detect the predetermined pressure and does not output an electrical signal. When holding mode sensors 408-#1, 408#2, 408-#3 and 408-#4 detect the predetermined pressure and output electrical signals (afterward, this state is called pressure vector P1 to facilitate explanation), it is estimated that a part of rubber band 103 between supporting member 104 and supporting member 106 is pulled as shown in FIG. 6.

Also, when holding mode sensors 408-#1, 408-#2 and 408-#3 detect the predetermined pressure and holding mode sensor 408-#4 does not detect the predetermined pressure (afterward, this state is called pressure vector P2 to facilitate explanation), it is estimated that a part of rubber band 103 between supporting member 104 and supporting member 105 is pulled as shown in FIG. 6.

Pressure vectors detected by the respective pressure sensors are outputted to CPU 410. CPU 410 estimates a form of rubber band 103 on the basis of the pressure vectors. It is possible as an estimation method for a form of rubber band 103 that CPU 410 compares a detected pressure vector with a relationship, which is preliminarily stored in memory 403, between various pressure vectors and various forms of rubber band 103, and estimates a form of rubber band 103 on the basis of the result of the comparison. Also, it is possible as an estimation method that CPU 410 estimates a form of rubber band 103 by processing a detected pressure vector while utilizing a program, which is preliminarily stored in memory 403, for estimation of a form of rubber band 103. CPU 410 outputs information regarding estimation of the form of rubber band to CPU 404.

In addition to P1 and P2, communication apparatus 100 can estimate various forms of rubber band 103 by processing various pressure vectors detected by holding mode sensors 408-#1, 408-#2, 408-#3 and 408-#4. Also the number of holding mode sensors 408 can be changed in accordance with the number of estimated forms of rubber band 103. In case of estimating two types of forms of rubber band 103, communication apparatus 100 needs at least one holding sensor 408.

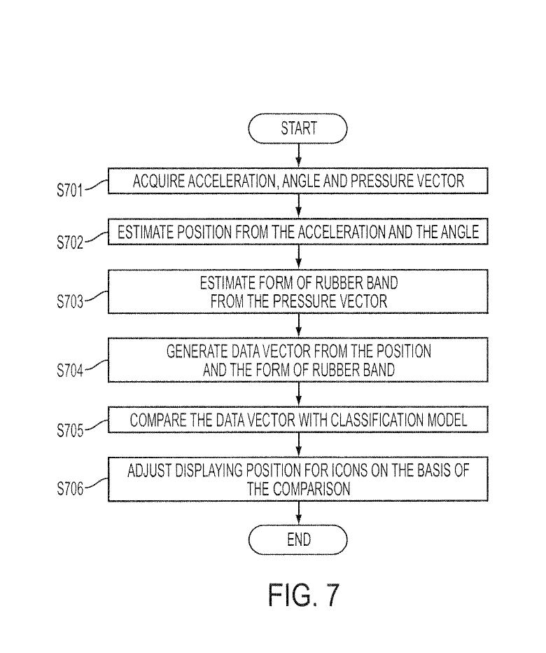

FIG. 7 shows a flowchart regarding control of the icon displaying position. At first, CPU 410 acquires each detection value from each sensor included in sensor array I/O sub system 411 (STEP 701). More specifically, CPU 410 acquires acceleration of communication apparatus 100 from acceleration sensor 405. Also, CPU 100 acquires angle and angular rate of communication apparatus 100 from gyroscopic sensor 406. Also, CPU 410 acquires a pressure vector from holding mode sensor 408.

Then, CPU 410 estimates a position of communication apparatus 100 from the acceleration, angle and/or angular rate (STEP 702). Then, CPU 410 estimates a form of rubber band 103 from the pressure vector (STEP 703). The data regarding estimated position of communication apparatus 100 and regarding estimated form of rubber band 103 are outputted to CPU 404. Then, CPU 404 generates a data vector by combining the data regarding estimated position of communication apparatus 100 and the data regarding estimated form of rubber band 103 (STEP 704).

Then, CPU 404 compares the generated data vector with classification data stored in memory (STEP 705). The classification data includes pre-stored data vectors which show combinations of a plurality of data regarding predetermined positions of communication apparatus 100 and a plurality of data regarding predetermined forms of rubber band 103. CPU 404 can estimate a position of communication apparatus 100 and a form of rubber band 103 by comparing the generated data vector and each of data vectors included in the classification data.

Then, CPU 404 adjusts the icon displaying position on the basis of the comparison result in STEP 705 (STEP 706). Accordingly, communication apparatus 100 can adjust the icon displaying position in accordance with the status of usage.

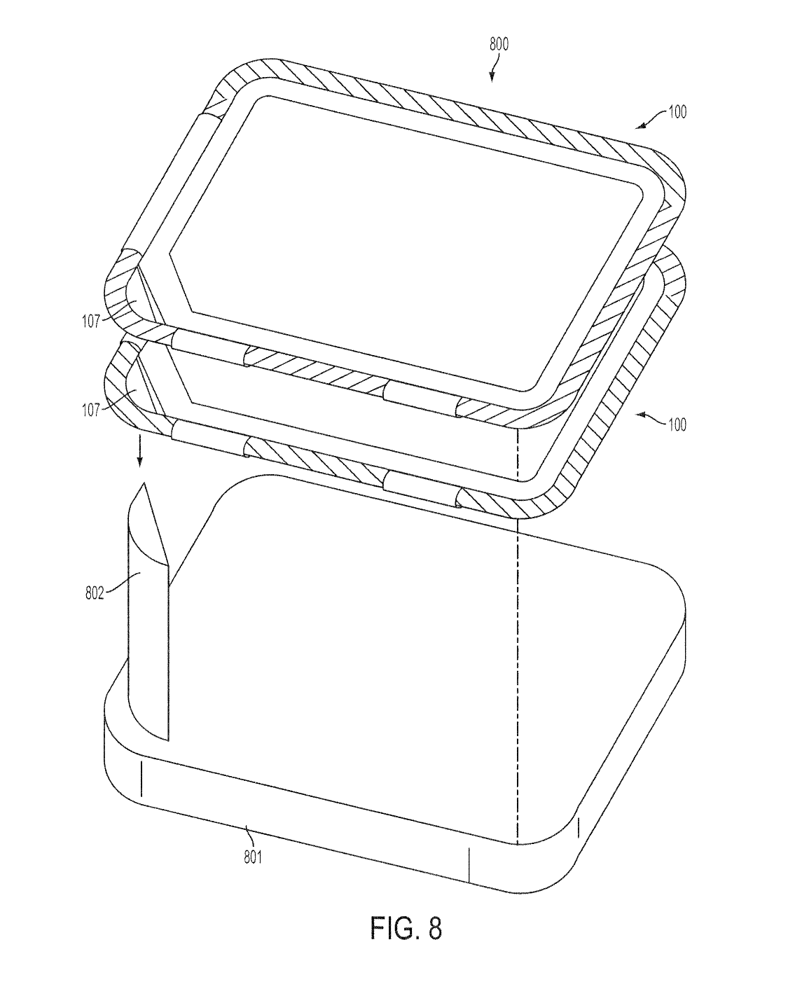

FIG. 8 shows an external view of communication apparatus 100 and a charging device 800. Charging device 800 includes base 801 for loading communication apparatus 100 and charging part 802. Communication apparatus 100 is provided power from charging device 800 via wireless charging. Base 801 and charging part 802 have an electrical circuit for wireless charging.

Communication apparatuses 100 is loaded on base 801 while inserting charging part 802 into space 107 when charging. As shown in FIG. 8, charging device can charge a plurality of communication apparatuses 100 at one time by stacking communication apparatuses 100. By stacking communication apparatuses 100 when charging, it is possible to reduce necessary space for charging. Charging part 802 has primary coils for power transmission. These primary coils are provided to positions corresponding to loading positions of each communication apparatus 100. Each primary coil is provided along the longitudinal direction of charging part 802. Each position of the primary coils corresponds to each of loading positions of communication apparatuses 100. Also, the charging device can be arranged on a wall.

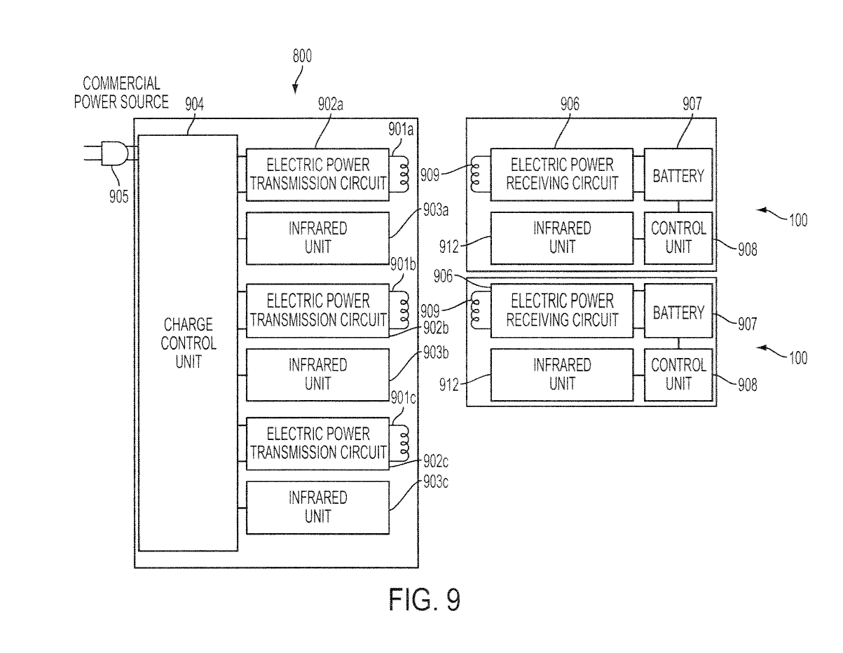

FIG. 9 shows hardware blocks of charging device 800 and hardware blocks of a power receiving system of communication apparatuses 100a, 100b. Charging device 800 includes primary coils 901a, 901b and 901c, electric power transmission circuits 902a, 902b and 902c, infrared circuits 903a, 903b and 903c, charging control unit 904 and plug 905. Primary coils 901a, 901b and 901c are used for transmitting power to communication apparatuses 100a, 100b through the use of inductive coupling. Electric power transmission circuits 902a, 902b and 902c adjust current, voltage and frequency regarding power transmitted by primary coils 901a, 901b and 901c. Infrared units 903a, 903b and 903c detect each of load of communication apparatuses 100a, 100b. Charging control unit 904 controls various operations of charging device 800. Plug 905 is connected to a commercial power source for supplying power to charging device 800.

On the other hand, power receiving system of each the communication apparatus 100a, 100b include induction coil 409, electric power receiving circuit 906, battery 907, infrared unit 412 and control unit 908, Induction coil 409 is used for receiving power from charging device 800 via inductive coupling. Electric power receiving circuit 906 supplies power received by induction coil 409 to battery 907. Infrared unit 412 notifies load of communication apparatus 100 to charging device 800. Control unit 908 controls various operations regarding charge of communication apparatus 100. Control unit 908 corresponds to CPU 404 and CPU 410 shown in FIG. 4. Communication apparatus 100a is mounted on base 801 directly when charging. Communication apparatus 100b is mounted on communication apparatus 100a when charging.

Primary coils 901a and 901b and infrared units 903a, 903b and 903c are provided in charging part 802 along the longitudinal direction of charging part 802. Primary coil 901a, electric power transmission circuit 902a and infrared unit 903a are used for charging of communication apparatus 100a. Also, primary coil 901b, electric power transmission circuit 902b and infrared unit 903b are used for charging of communication apparatus 100b. Primary coil 901c, electric power transmission circuit 902c and infrared unit 903c are used for charging of communication apparatus 100 mounted on communication apparatus 100b. However, there is no other communication apparatus mounted on communication apparatus 100b. Therefore, primary coil 901a, electric power transmission circuit 902a, and infrared unit 903c are not activated in this charging operation shown in FIG. 8 and FIG. 9.

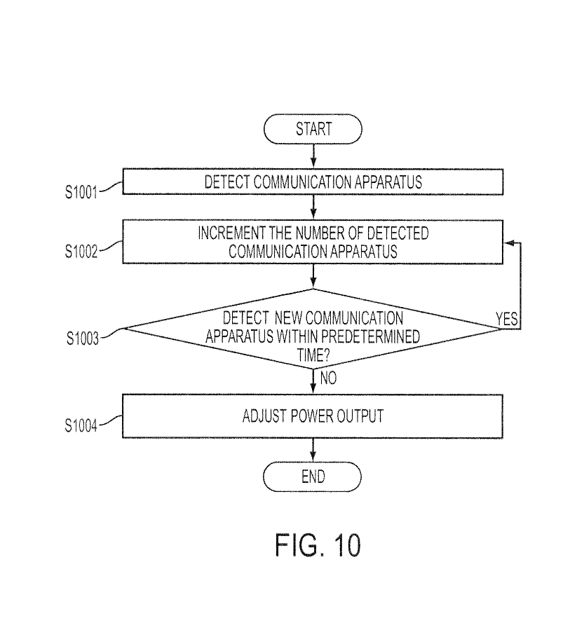

FIG. 10 shows a flowchart regarding motion of charging device 800 in a charging operation. Communication apparatus 100 transmits an infrared signal from infrared unit 412 to infrared unit 903 of charging device 800 when the communication apparatus is loaded on charging device 800. When each of infrared units 903a, 903b and 903c receives an infrared signal transmitted from infrared unit 412, each of infrared units 903a, 903b and 903c provide a notification that a communication apparatus is loaded on charging device 800 to charge control unit 904 (STEP 1001). Then, charge control unit 904 increments the number of detected communication apparatuses on the basis of outputs from each of infrared units 903a, 903b and 903c (STEP 1002). Charge control unit 904 can detect the number of loaded communication apparatuses 100 by incrementing outputs from each of infrared units 903a, 903b and 903c.

Then, charge control unit 904 checks whether a new communication apparatus 100 is detected within a predetermined time (STEP 1003). If a new communication apparatus 100 is detected within the predetermined time, charge control unit 904 increments the number of detected communication apparatuses 100. On the other hand, if a new communication apparatus is not detected within the predetermined time, charge control unit 904 implements next step 1004. Then, charge control unit 904 adjusts the power output transmitted to communication apparatuses 100 in accordance with the number of detected communication apparatuses 100 (STEP 1004). In case of the example shown in FIG. 9, the number of detected communication apparatuses becomes two, and charge control unit 904 supplies power to primary coil 902a and 902b. Also, it is possible that detection of inductive coupling between primary coils 901a, 901b and 901c and induction coil 409 may be utilized to indicate detection of communication apparatuses 100.

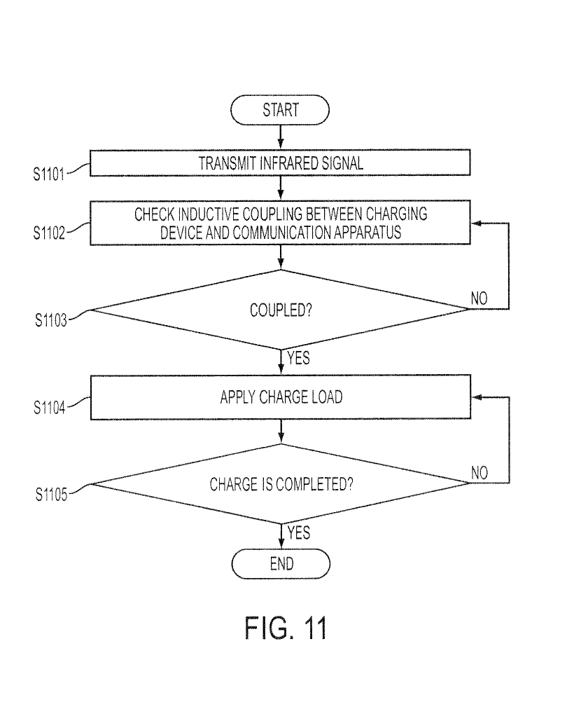

FIG. 11 shows a flowchart regarding motion of the communication apparatus in a charging operation. When communication apparatus 100 is mounted on charging device 800, an infrared unit transmits an infrared signal to infrared unit 903 of charging device 800 (STEP 1101). Then, control unit 908 checks whether induction coil 409 is inductively coupled with primary coil 901. Confirmation of inductive coupling is implemented via electric power receiving circuit 906 (STEP 1102). Control unit 908 continues checking of the inductive coupling until control unit 908 checks the inductive coupling (STEP 1103). After confirmation of inductive coupling with charging device 800, control unit 908 supplies power to battery 907 via electric power receiving circuit 906 (STEP 1104). Then, charge control unit 908 checks whether the charge to battery 907 is finished based on information from battery 907. Power supply to battery 907 is continued until the charge is completed (STEP 1105).

Moreover, charging device 800 can operate an authentication process for communication apparatuses 100 by utilizing infrared communication implemented by infrared unit 903. In case of implementing an authentication process, unique IDs corresponding respectively to each of communication apparatuses 100 are pre-stored in charge control unit 904. Then, each of communication apparatuses 100 transmits its unique ID to charging device 800 via infrared unit 412. Then, charging device 800 receives the unique ID via infrared unit 903. Charge control unit 904 compares the received unique ID with the pre-stored unique ID to determine whether communication apparatus 100 is an accepted or regular charging objective. If the received unique ID accords with the pre-stored unique ID, the charge control unit starts the charge to the authenticated communication apparatus 100. If the received unique ID does not accord with the pre-stored unique ID, charge control unit does not implement charge to communication apparatus 100. By doing so, it becomes possible that charging device 800 prevents unnecessary charge.

In addition to a communication apparatus such as a tablet device, it is also possible that the above-described structure utilizing rubber band and control of a user interface displaying position may be applied to remote control devices and other transportable electric devices.

Other embodiments will be apparent to those skilled in the art from consideration of the specification and practice of the invention described in detail herein. It is intended that the specification and examples be considered as exemplary only, with a true scope and spirit of the invention being indicated by the following claims.

1. An apparatus comprising:
a housing;
a band which is provided on side of the housing and has a longer length than a circumference of the housing; and
a supporter configured to support the band of the side of the housing to enable the band to slide along the side of the housing.

2. The apparatus according to claim 1, wherein:
the band comprises rubber material.

3. The apparatus according to claim 1, wherein:
the housing has at least one chamfered corner.

4. The apparatus according to claim 1, further comprising:
a detector configured to detect a form of the band;
a display configured to display a user interface for operating the communication apparatus; and
a controller configured to control a display position of the user interface based on the form of the band.

5. The apparatus according to claim 4, wherein:
the detector comprises at least one pressure sensor disposed on the side of the housing, the pressure sensor being configured to detect pressure applied by the band on the housing, and
the controller is configured to estimate and provide an estimation result of the form of the band on the basis of the pressure and to control the display position of the user interface on the basis of the estimation result.

6. The apparatus according to claim 5, further comprising:
a position detector configured to detect a position of the communication apparatus,
wherein the controller is configured to control the display position of the user interface on the basis of the position of the communication apparatus and the form of the band.

7. The apparatus according to claim 6, wherein:
the position detector includes an acceleration sensor configured to detect an acceleration of the communication apparatus and a gyroscopic sensor configured to detect an angle of the communication apparatus.

8. The apparatus according to claim 4, wherein:
the user interface comprises at least one of an icon, command, a software keyboard and an operating screen for controlling the communication apparatus.
